(19) United States
(12) Patent Application Publication
(10) Pub. No.: US 2025/0383935 A1
(43) Pub. Date: Dec. 18, 2025

(54) METHOD AND SYSTEM FOR ADJUSTING POD RESOURCES

(71) Applicant: Intuit, Inc., Mountain View, CA (US)

(72) Inventors: Xiaotang SHAO, Cupertino, CA (US); Navin Kumar JAMMULA, Dublin, CA (US); Zihan JIANG, Foster City, CA (US); Hui LUO, Fremont, CA (US); Sen LIN, Santa Clara, CA (US); Chun-Che PENG, San Diego, CA (US); Shreyas BADIGER MAHADEV, Santa Clara, CA (US)

(21) Appl. No.: 18/744,353

(22) Filed: Jun. 14, 2024

(51) Int. Cl. G06F 9/50

(52) U.S. Cl. CPC G06F 9/5077; G06F 9/5016; G06F 9/5027; G06F 2209/501; G06F 2209/505; G06F 2209/506

(57) ABSTRACT

Certain aspects of the disclosure provide a method for adjusting resources of a pod. Resource utilization metrics and resource configuration of a pod running on a node in a cluster of nodes are received and stored in a metrics data store. A selected CPU request, a target CPU limit, a selected memory request, and a target memory limit is calculated based on the resource utilization metrics and the resource configuration. A recommendation for rescaling CPU and memory for the pod is generated based on the selected CPU request, the target CPU limit, the selected memory request, and the target memory limit. A new pod is created in the cluster based on the recommendation. After the new pod is created, the pod running on the node is deleted.

### BACKGROUND

### Field

Aspects of the present disclosure relate to containers, and in particular, to adjusting resources for containers running in pods of a node cluster.

### Description of Related Art

Traditionally, software was implemented in monolithic applications run on physical computer systems. A monolithic application is a self-contained software program in which the user interface, application programming interfaces, data processing, and data access code are implemented in a single program. However, running multiple monolithic applications on the same computer system created resource sharing conflicts because monolithic applications run independently of one another. For example, if multiple monolithic applications are run on the same computer system, typically one of the applications dominates resource usage. As a result, the other applications running on the same computer system are delayed or underperform. One solution was to run each application on a different computer system. This approach created increased costs to maintain a separate computer system for each instance of an application and resulted in underutilized or wasted resources because not all applications use resources in the same manner across the computer systems.

Virtualization was introduced to help resolve issues associated with underutilized and wasted resources and increase computational efficiency and productivity. Virtualization allows for the creation of multiple virtual machines (VMs) to run multiple applications on a single computer system and paved the way for distributed applications with independent application components called microservices running separately in VMs. VMs virtualize the computer system down to the hardware layer, including virtualization of the CPU, memory, and storage, and independently run applications or microservices on separate operating systems (OSs). Although each VM runs its own OS and functions separately from other VMs running on the same computer system, virtualization management tools have been developed to ensure that VMs running on the same computer system share computer resources to increase efficiency and reduce resource wastage and bottlenecks.

Virtualization has expanded to include containers for running applications and microservices. A container is a software package that contains the application or microservice and dependencies, such as libraries and files, used to run the application or microservice. By contrast to VMs, containers virtualize software layers above the OS level. In other words, containers are similar to VMs in running applications and microservices in separate virtual environments, but containers have relaxed isolation properties in order to share the same OS among the containers running on the same computer system. As a result, a single OS can support multiple containers, each container running within a separate execution environment.

In recent years, platforms for managing containerized workloads have been developed to provide support services, such as adjusting the amount of CPU and memory available to run containers based on historical demand for resources. However, CPU and memory size settings assigned to containers do not often match current requirements of the containers, which has a direct impact on containerized application performance. For example, a typical container management platform adjusts the amount of resources available to containers based on a historical demand for resources that is closest to the current demand for resources, which results in either under provisioning or over provisioning of resources to the containers. As a result, if the platform fails to allocate enough resources to run the containers, the containerized workloads will suffer from performance degradation or bottlenecks. On the other hand, if the platform over provisions resources to run the containers the unused resources are wasted.

### SUMMARY

Certain aspects provide a computer-implemented method for adjusting resources of a pod. The method comprises receiving resource utilization metrics and resource configuration of the pod running on a node in a cluster of nodes from a metrics collector. A selected CPU request, a target CPU limit, a selected memory request, and a target memory limit are calculated based on the resource utilization metrics and the resource configuration. A recommendation for rescaling CPU and memory for the pod is generated based on the selected CPU request, the target CPU limit, the selected memory request, and the target memory limit. A new pod is created in the cluster in based on the recommendation. The pod running on the node is deleted.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example of containers running in pods on a computer system.

FIG. 2 depicts an example architecture of a cluster of nodes.

FIG. 3 depicts an example architecture of a pod resource recommender.

FIGS. 4A-4C depict an example of forming a data frame object for a pod based on CPU usage.

FIG. 5A depicts an example of partitioning CPU usage into CPU usage intervals.

FIG. 5B depicts a data frame object with CPU usage values, memory usage values, latencies, and error rates that belong to a CPU bucket.

FIG. 6A depicts an example pseudocode for determining a maximum allowable latency, a maximum allowable error rate, and a minimum selected memory request for CPU buckets.

FIG. 6B depicts an example of determining the maximum allowable latency based on a top percentile of ninety percent of latencies.

FIG. 6C depicts an example of determining the maximum allowable error rate based on a tope percentile of twenty percent of latencies.

FIG. 7 depicts an example pseudocode for determining a selected CPU bucket.

FIG. 8 depicts an example pseudocode for calculating a selected CPU limit and a selected CPU memory limit.

FIG. 9A depicts an example pseudocode for scaling down a target CPU request and a target CPU limit and scaling down a target memory request and a target memory limit.

FIG. 9B depicts an example pseudocode for scaling up a target CPU request and scaling up a target memory request.

FIG. 10 depicts a flow diagram of a method for adjusting pod resources.

FIG. 11 depicts a flow diagram a “compute a selected CPU request, a target CPU limit, a selected memory request, and a target memory limit” process in FIG. 10.

FIG. 12 depicts a “determine a selected CPU bucket” process in FIG. 11.

FIG. 13 depicts a “compute resource recommendation” process in FIG. 11.

FIG. 14 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for adjusting resources of pods running in clusters of nodes. The methods and systems described herein incrementally adjust allocation of resources, such as CPU and memory, to the pods in response to changes in the workloads of the containers running in the pods. The methods and systems collect resource utilization metrics and resource configuration of the pods and generate a recommendation for scaling up or down the resources based on the resource utilization metrics and resource configuration information. The recommendation is recorded in a pod specification. For each update of the pods, the deployment controller checks the pod specification for changes in resource allocation and creates new pods in accordance with the recommendations. The new pods run the same containers as old pods created under the previous pod specification. The previous or old pods are subsequently deleted to avoid downtime after the new pods are deployed. The process of updating the allocation of resources and generating a recommendation can be repeated prior to each update of the pods to ensure that the pods are running with an up to date allocation of resources based on changing demands for resources.

Typical platforms for managing containerized workloads have been developed for adjusting the amount of CPU and memory available to containers. However, the adjustments are based on historical demand for resources. For example, a typical container management platform adjusts the amount of resources available to containers based on a historical demand for resources that is closest to the current demand for resources, which creates the problem of under provisioning resources or the problem of over provisioning resources to the container.

To overcome the disadvantages of relying on historical demand for resources, embodiments described herein perform an incremental adjustment to the allocation of resources to individual pods during pod updates in response to changing workloads of the containers running in the pods. As the demand for resources increase, embodiments described have the advantage of incrementally scaling up the allocation of resources to pods to match an increasing demand for resources. On the other hand, as the demand for resources decreases, the allocation of resources can be scaled down again to match a decreased demand for resources and avoid resource wastage.

Embodiments described herein avoid the problems of over provisioning or under provisioning resources because the allocations are not determined by prior unrelated allocations of resources that do not match or approximate the current demand for resources of containerized workloads.

### Example Implementation of a Method for Adjusting CPU and Memory Usage of Pods in a Cluster of Nodes

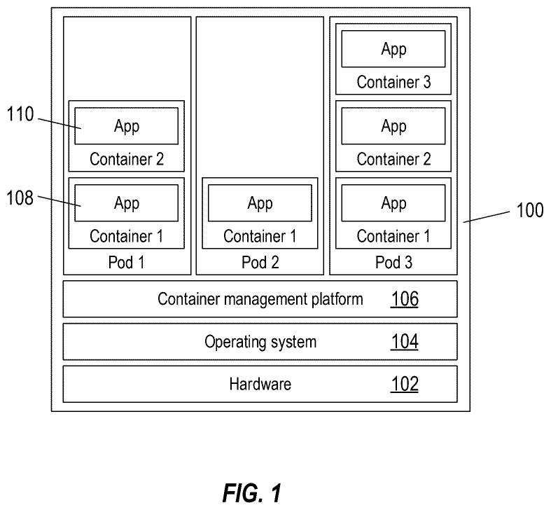

FIG. 1 depicts an example of containers running in pods on a computer system 100. The computer system 100 is an example of a node that includes a hardware layer 102 composed of processors, memory, storage, and network interfaces, such as a high speed network interface card. The computer system 100 includes an OS layer 104 that manages computer hardware, software resources, and provides services for computer programs executing on the computer system 100. A container management platform 106 is a server application for containerizing software and applications. In this example, software or microservices, denoted by “App,” are run separately in containers that are, in turn, run in pods identified as “Pod 1,” “Pod 2,” and “Pod 3.” Each pod runs one or more containers with shared CPU, memory, storage and network resources according to a pod specification that includes a request for resources that the pod can use to execute the workload. For example, Pod 1 runs an App 108 in a container identified as Container 1 and another App 110 in a container identified as Container 2. The App 108 and App 110 share a fixed amount of CPU, memory, and storage assigned to Pod 1 according to a pod specification. The container management platform 106 manages the pods and does not manage the containers directly.

In other implementations, pods can also be run in VMs. In this case, a VM is regarded as a node. Multiple nodes running pods is called a cluster that is managed by a control plane. The control plane runs across multiple computers and a cluster is typically composed of multiple nodes, which provides fault-tolerance and high availability. Fault tolerance is the ability of the cluster to continue operating without interruption when one or more of the nodes or pods fail. Fault-tolerance prevents service disruptions arising from a single point of failure. Fault-tolerant systems use backup components, such as pod replicas, that automatically take the place of a pod that fails to perform to ensure no loss of service.

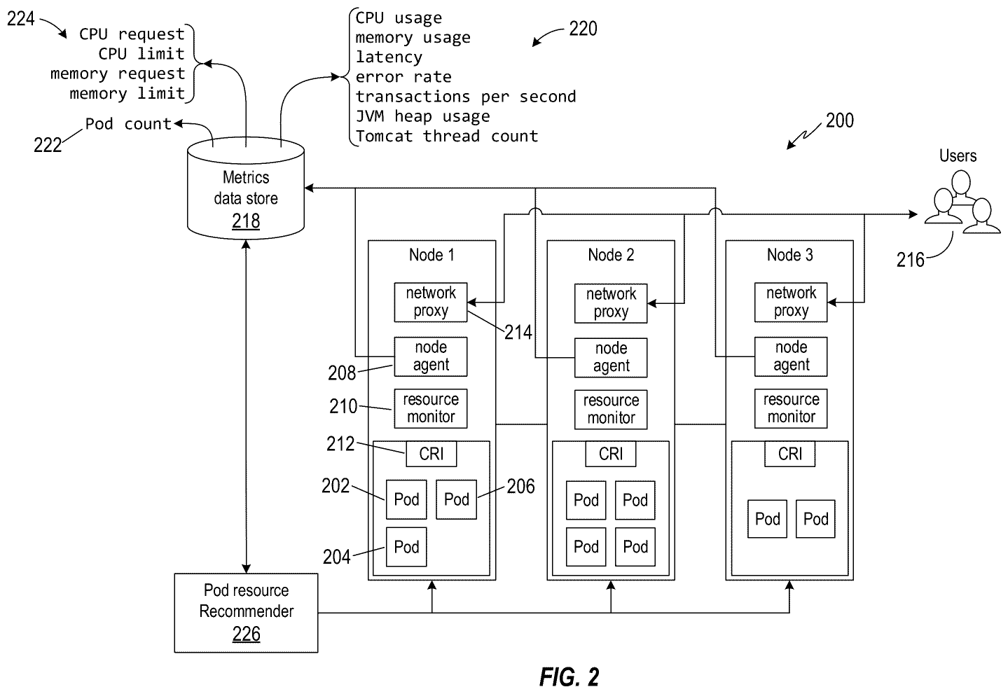

FIG. 2 depicts an example architecture 200 of a cluster of three nodes identified as Node 1, Node 2, and Node 3. In this example architecture, each node runs multiple pods and contains services to run the pods. The nodes can be physical computer systems, VMs, or a combination of physical computers and VMs. In the example of FIG. 2, Node 1 runs pods 202, 204, and 206 and includes a node agent 208 that manages Node 1 and coordinates execution of the pods 202, 204, and 206. The node agent 208 managers pod startup and shutdown and handles resource allocation to the pods according to a pod specification. The pod specification includes directions for how to run the containers and the resource requests for the pods, such as allocation of CPU and memory. For example, an example pod specification includes requests for CPU usage and memory usage. Node 1 includes a resource monitor 210 that maintains a record of resource usage by the pods. For example, the resource monitor 210 maintains a record of resource metrics, such as CPU usage, memory usage, latency, error rate, transactions processed per second (TPS), and other metrics. Node 1 includes a container runtime interface (CRI) 212 that enables the node agent 208 to use more than one type of container runtime. A container runtime is the software that is responsible for running containers. Node 1 includes a network proxy 214 that enables network communication of the pods 202, 204, and 206 to network sessions inside and outside of the cluster. For example, the network proxy 214 enables network communication between the software and microservices running in the pods 202, 204, and 206 and users 216.

The example architecture 200 includes a metrics data store 218 that temporarily stores pod and container metrics output from the resource monitors of the nodes. Each metric is a sequence of time-series metric values generated by a node object or service, such as an operating system, a resource, software running in a pod, or a microservice running in pod. The metric values are generated at points in time called “time stamps.” A metric can be denoted by

$${( {x}_{i} )}_{i = 1}^{N} = {( x ( {t}_{i} ) )}_{i = 1}^{N} ,$$

where N is the number of metric values in a sequence of metric values, xᵢ=x(tᵢ) is a metric value, and tᵢ is a time stamp indicating when the metric value was generated in a time interval [t₁, t_{N}].

The metrics data store 218 stores resource utilization metrics 220, including CPU usage, memory usage, latency, error rate, and TPS. The resource utilization metrics 220 may also include a thread count, such as Tomcat® thread count, and a JAVA™ VM heap usage for JAVA™ applications running in the pods.

The metrics data store 218 records a pod count 222 of the number of pods currently running in the nodes.

The metrics data store 218 stores resource configuration requests and the resource configuration limits 224, such as CPU requests, CPU limits, memory request, and memory limits for each of the containers and the pods running in the nodes. Requests and limits are used to control use of CPU and memory by the containers. A limit is the maximum amount of a resource to be used by a container. In other words, a container cannot consume more memory and CPU than the memory limit and CPU limit. On the other hand, a request is the minimum guaranteed amount of a resource that is reserved for a container. For example, a container may have a CPU limit of 1000millicores and a memory limit 600 MB. The container may have a CPU request of 500 millicores and memory request of 300 MB. The container can use at least 500 millicores of CPU and 300MB, but the container cannot exceed 1000 millicores of CPU and 600 MB of memory. The CPU request for a pod is the sum of the CPU requests for the containers running in the pod. The CPU limit for a pod is the sum of the CPU limits for the containers running in the pod. Likewise, memory requests and memory limits are associated with the containers of a pod. The memory request for a pod is the sum of the memory requests for the containers running in the pod. The memory limit for a pod is the sum of the memory limits for the containers running in the pod.

The metrics data store 218 forwards current values of the resource utilization metrics 220, the updated pod count 222, and resource configuration limits 224 to a pod resource recommender 226.

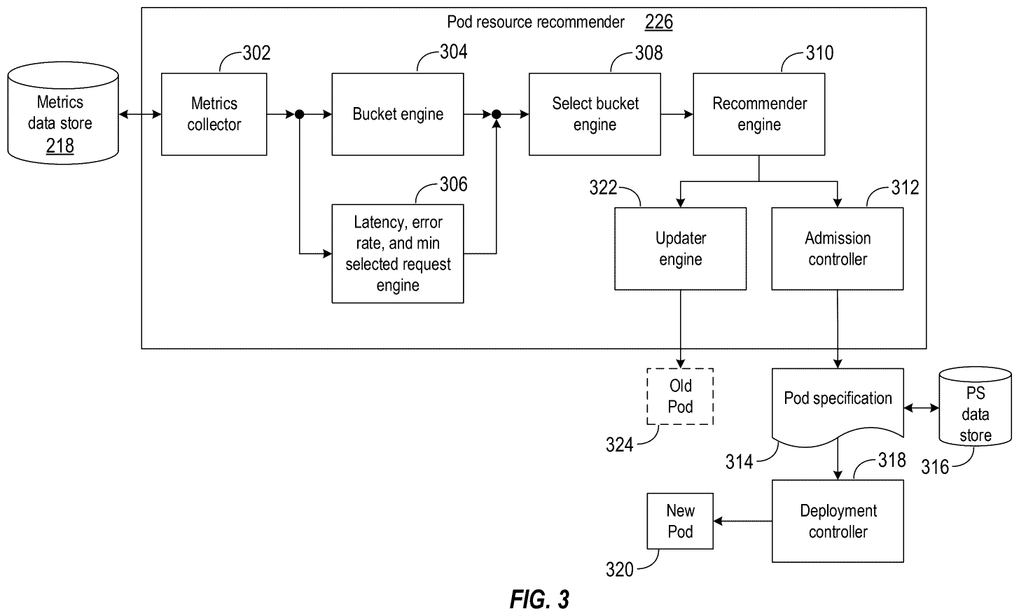

FIG. 3 depicts an example architecture of the pod resource recommender 226. The pod resource recommender 226 includes a metrics collector 302 that receives metrics sent from the metrics data store 218 or actively retrieves metric data from the metrics data store 218.

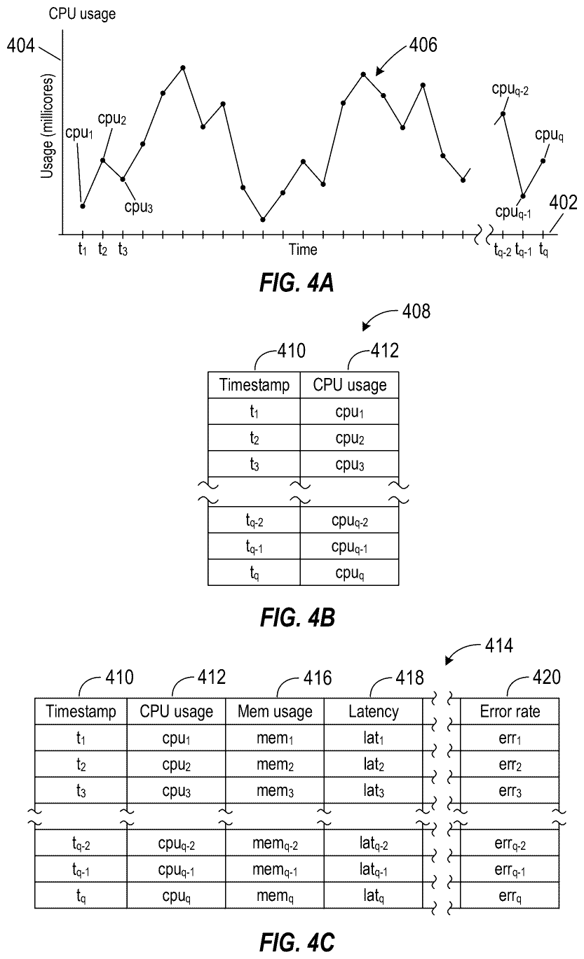

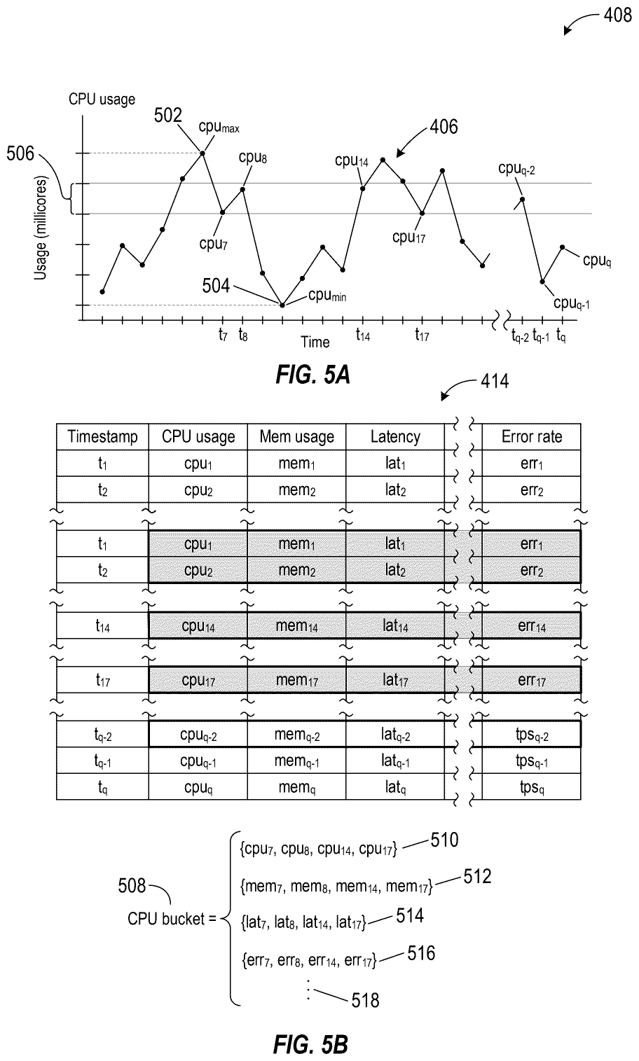

A bucket engine 304 receives metrics from the metric collector 302. The bucket engine 304 combines the metrics into a data frame object, as described below with reference to FIGS. 4A-4C. The bucket engine 304 generates CPU buckets of metrics from the data frame object as described below with reference to FIGS. 5A-5B. Each CPU bucket corresponds to a range of CPU usage and contains metric values of other metrics that correspond to the range.

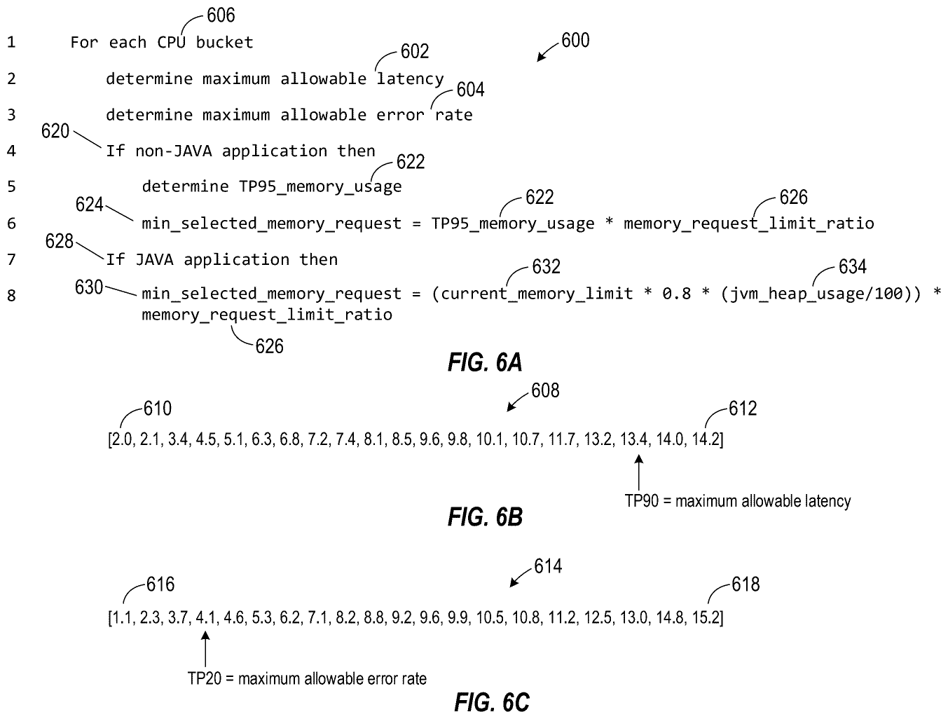

A compute maximum latency, error rate, and minimum selected memory request engine 306 determines maximum allowable latency, maximum allowable error rate, and a minimum selected memory request for each of the CPU buckets generated by the bucket engine 304 as described below with reference to FIGS. 6A-6C.

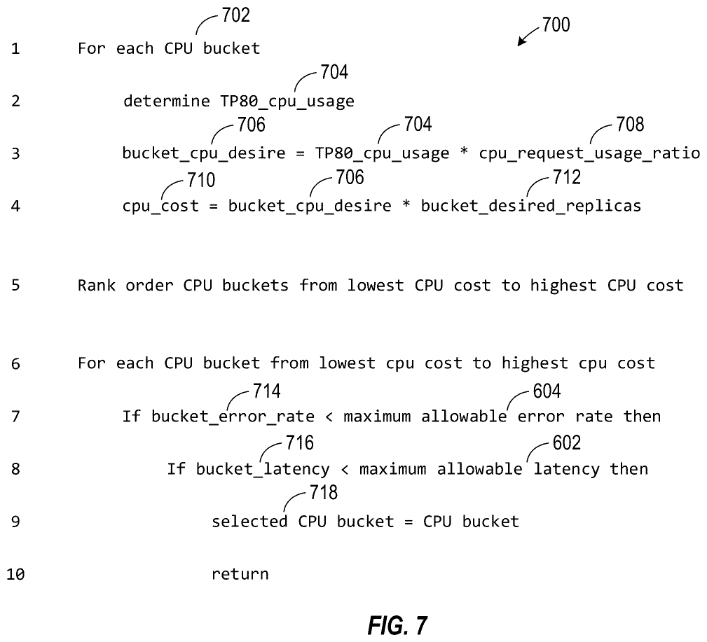

A select bucket engine 308 determines which of the CPU buckets created by the bucket engine 304 is a selected CPU bucket based on the maximum allowable latency and maximum allowable error rate output from the engine 306 as described below with reference to FIG. 7. The selected CPU bucket is the CPU bucket of the CPU buckets created by the bucket engine 304 with the lowest CPU cost in terms CPU usage, CPU requests, and number of desired pod replicas.

In the discussion below, the terms “current,” “target,” and “selected” are used to describe the amount of resources requested to run a pod. A pod that is running on a node has an associated request for an amount of CPU and memory from a node agent of the node. The node agent reserves at least the amount of CPU or memory requested for the pod. The amounts of CPU and memory reserved for the pod by the node agent is called the “current CPU request” and the “current memory request,” respectively. However, the current CPU request or the current memory request may not be correct because the request may be for more resources than are actually available or are not sufficient to meet the actual processing and memory requirements of the pod.

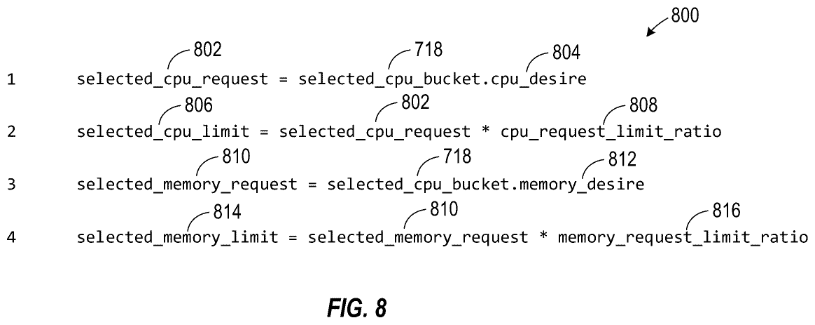

A recommender engine 310 determines a selected CPU recommendation and a selected memory recommendation based on the metrics of the selected CPU bucket identified by the selected bucket engine 308. The recommender engine 310 calculates selected resource requests, such as a selected CPU request and a selected memory request, to closely fit the actual CPU usage and memory usage of applications running in containers of the pod, thereby reducing errors and latency issues with the applications running in the pod. The recommender engine 310 calculates a selected CPU request, selected CPU limit, a selected memory request, and selected memory limit based on the metric values of the selected CPU bucket identified by the selected bucket engine 308 as described below with reference to FIG. 8.

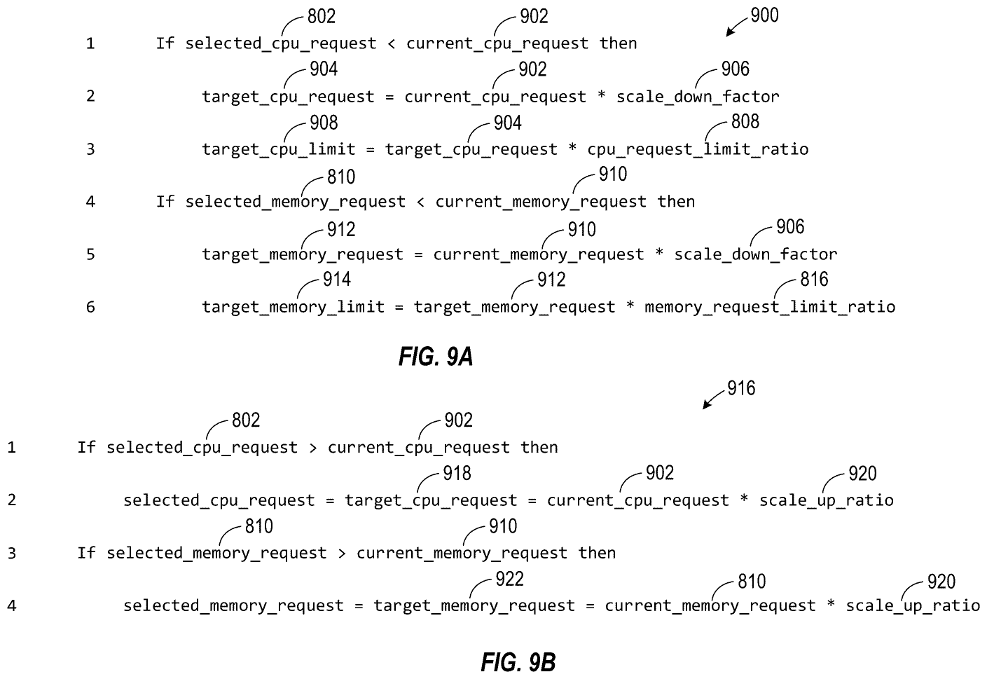

If the selected CPU request is less than the current CPU request, the recommender engine 310 calculates a target CPU request and a target CPU limit as described below with reference to FIG. 9A. If the selected memory request is less than the current CPU request, the recommender engine 310 calculates a target memory request and target memory limit as described below with reference to FIG. 9A.

If the selected CPU request is greater than the current CPU request, the recommender engine 310 calculates a selected CPU request and a target CPU request as described below with reference to FIG. 9B. If the selected memory request is greater than the current CPU request, the recommender engine 310 calculates a selected memory request and a target memory request as described below with reference to FIG. 9B.

The selected resource request for the pod may not be immediately implemented when there is a significant difference between the current CPU request and the selected CPU request or a significant difference between the current memory request and the selected memory request. Instead, a target CPU request and target memory request can be used for the pod to avoid the possibility of large change in the resource settings for the pod. For example, if the selected CPU request is more than 10% less than the current CPU, the target resource request may be calculated as the current resource request scaled down by 10% of the current resource request. For example, if the selected CPU request is more 20% greater than the current CPU request, the target resource request may be the current resource request scaled up by 20% of the current resource request. After the target CPU request and the target memory request have applied to run the pod, the target CPU request and the target memory request become the current CPU request and the current memory request, respectively.

An admission controller 312 overwrites the changes to the selected CPU request and the target CPU request and changes to the selected memory request and the target memory request to the pod specification 314 stored in a pod specification (PS) data store 316.

A deployment controller 318 executes a rolling update to deploy a new pod 320 created according the updated pod specification 314. The new pod 320 runs the same containers as an old pod 324 that was created under the previous or preceding version of the pod specification. After the new pod 320 has been created in accordance with changes to the pod specification 314, an updater engine 322 deletes or destroys the old pod 324. The new pod 320 replaces the old pod 324 deleted by the updater engine 322. The new pod 320 may have been deployed in the same node or on a different node of the cluster in accordance with the selected CPU request, the target CPU request, the selected memory request, and the target memory request generated by the recommender engine 310. The rolling update can be performed one or more times per day to ensure that the pods are running the most up to date requests, targets, and limits.

For each rolling update of the pods, a recommendation can be generated as a result of the operations performed by the metrics collector 302, the bucket engine 304, the latency, error rate, and minimum selected request engine 306, the selected bucket engine 308, and recommender engine 310. The deployment controller 318 checks the pod specification for changes in resource allocation prior to the start of each rolling update. If there are changes to the pod specification, the deployment controller 318 creates a new pod 320 in accordance with the recommendations recorded in the pod specification 314. The previous or old pods are subsequently deleted from the nodes by the updater engine 322 to avoid downtime while the new pod 320 is deployed. The process of updating the allocation of resources and generating a recommendation can be repeated prior to each rolling update to ensure that the pods are running with an up-to-date allocation of resources based on changing demands for resources by the containers in the pod.

Note that although operations of the pod resource recommender 226 are described below with reference CPU usage and CPU buckets, embodiments are not intended to be limited to CPU usage and CPU buckets. In other implementations, processes can be implemented for a different metric, such as memory usage, to create memory buckets.

FIGS. 4A-4C depict an example of forming a data frame object for a pod based on CPU usage as performed by the bucket engine 304 in FIG. 3. The pod can run a single container, such as Pod 2 in FIG. 1, or run multiple containers, such as Pod 1 and Pod 3 in FIG. 1.

FIG. 4A displays an example plot of CPU usage for the pod. A time axis 402 represents a continuous range of time and CPU usage axis 404 represents a range of CPU usage values. Curve 406 represents CPU usage at regularly spaced time stamps represented by equally spaced markings over a time interval that starts at time t₁ and ends at time to along the time axis 402, where q is the number of time stamps in the time interval [t₁, t_{q}]. CPU usage values at the time stamps are denoted by cpu;, where i=1, . . . , q. For example, CPU usage at the spaced apart time stamps t₁, t₂, and t₃ are represented by corresponding points identified as cpu₁, cpu₂, and cpu₃.

The CPU usage is measured in units of millicores. One millicore corresponds to one thousandth of a core. On the other hand, a CPU usage of 0.1 is equivalent to 100 millicores. For example, a four core node can run up to sixteen pods each have 250 millicores. If a node has 2 cores, the node's CPU capacity is represented as 2000 millicores.

FIG. 4B displays a table that represents an initial stage of forming the data frame object 408 based on CPU usage of the pod. Column 410 contains the list of time stamps. Column 412 contains the list of corresponding CPU usage in millicores at the time stamps.

FIG. 4C displays a table that represents a data frame object 414 expanded to include other metrics associated with the pod. Column 416 contains metric usage of the pod at the time stamps. Column 418 contains latencies at the time stamps. Column 420 contains the error rates at the time stamps.

The bucket engine 304 partitions the range of CPU usage between the minimum CPU usage, cpuₘᵢₙ, and the maximum CPU usage, cpuₘₐₓ, over the time interval [t₁, t_{q}] into M number of CPU usage intervals (i.e., number of buckets). The length of each CPU usage interval, called the “bucket length” is given by

$$bucket\_length = \frac{{cpu}_{max} - {cpu}_{min}}{M} \qquad ( 1 )$$

Each CPU usage interval corresponds to a CPU bucket. A CPU bucket is formed from the metrics of the data frame object with metric values that correspond to time stamps of CPU usage values that lie within the corresponding CPU usage interval.

FIG. 5A depicts an example of partitioning the CPU usage into five CPU usage intervals as performed by the bucket engine 304 in FIG. 3. A point represents a maximum CPU usage 502 over the time interval [t₁, t_{q}]. A point represents a minimum CPU usage 504 over the time interval [t₁, t_{q}]. In this example, the CPU usage ranges between the maximum CPU usage 502 and the minimum CPU usage 504 is partitioned into five CPU usage intervals (i.e., M=5) each with a bucket length determined according to Eq. (1). For example, CPU usage interval 506 contains CPU usage values cpu₇, cpu₈, cpu₁₄, cpu₁₇, and cpu_{q-2} that correspond to the time stamps t₇, t₈, t₁₄, t₁₇, and t_{q-2}.

FIG. 5B depicts the data frame object 414 with shaded table entries that correspond to memory usage values, latencies, and error rates at the time stamps t₇, t₈, t₁₄, t₁₇, and t_{q-2}. A set of CPU usage values 510, a set of memory usage values 512, a set of latencies 514, and a set of error rates 516 at the time stamps t₇, t₈, t₁₄, t₁₇, and t_{q-2} are elements of the CPU bucket 508. Other metric values not represented in the example data frame object 414 are represented by ellipses 518.

Each CPU bucket contains the sets of metric values for a corresponding CPU interval of the range of CPU usage between the maximum CPU usage 502 and the minimum CPU usage 504 as described above with reference to FIGS. 5A-5B.

FIG. 6A depicts an example pseudocode 600 for determining a maximum allowable latency 602, a maximum allowable error rate 604, and a minimum selected memory request for each CPU bucket 606 as performed by the engine 306 in FIG. 3. A for loop beginning with line 1, repeats the operations in lines 2-8 for each CPU bucket. In line 2, the maximum allowable latency 602 is determined using a top percentile TP90 of the latencies in the CPU bucket.

FIG. 6B depicts an example of determining the maximum allowable latency based on TP90. TP90 latency is determined by rank ordering the latencies in the CPU bucket in ascending order from the shortest latency to the longest latency. Consider an example set of twenty rank ordered latencies 608 ranked from the shortest latency 610 to the longest latency 612. The ceiling of the rank ordered latencies 608 is given by ceil (20*0.90)=18, where ceil (X) is the ceiling function. The ceiling function maps the number X to the smallest integer that is greater than or equal to X. As a result, the maximum allowable latency is the 18^{th} longest latency in the set of ranked latencies 608. In other words, the maximum allowable latency (TP90) is 13.4.

Returning to FIG. 6A, in line 3, the maximum allowable error rate 604 is determined using a top percentile TP20 of the error rates in the CPU bucket.

FIG. 6C depicts an example of determining the maximum allowable error rate based on TP20. TP20 is determined by rank ordering the error rates in the CPU bucket in ascending order from the smallest error rate to a largest error rate. Consider an example set of twenty rank ordered error rates 614 rank ordered from the smallest latency 616 to the largest latency 618. The ceiling of the rank ordered error rates 614 is given by ceil (20*0.40)=4. As a result, the maximum allowable error rate is the 4^{th} largest error rate in the set of rank ordered error rates 614. In other words, the maximum allowable error rate (TP20) is 4.1.

In line 4, FIG. 6A, if the application running in the pod is a non-JAVA™ application in conditional statement 620, a TP95 memory usage 622 is determined in line 4. TP95 memory usage 622 is determined by rank ordering the memory usage values from a smallest memory usage value to a largest memory usage value of the memory usage values in the CPU bucket. The ceiling of the rank ordered values is given by ceil (Q*0.95), where Q is the number of memory usage values in the CPU bucket. The TP95 memory usage 622 is the memory usage value that corresponds the ceil (Q*0.95) position in the rank ordered set of memory usage values as described above with reference to FIGS. 6B-6C. In line 6, a minimum selected memory request 624 is computed as the product of the TP95 memory usage 622 and a memory request limit ratio 626. For example, the memory request limit ratio 626 can be set to 1.2.

Alternatively, in line 7, if the application running in the pod is a JAVA™ application in conditional statement 628, a minimum selected memory request 630 is computed based on a current memory limit 632, a JVM heap usage 634 of the resource utilization metrics 220 in FIG. 2, and the memory request limit ratio 626. For a JAVA™ application, the selected memory request 630 equals the current memory limit 632.

FIG. 7 depicts an example pseudocode 700 executed by the bucket engine 308 in FIG. 3 for determining a selected CPU bucket as performed by the bucket engine 308. The bucket engine 308 determines which of the CPU buckets determined by bucket engine 304 is a selected CPU bucket based on the maximum allowable latency and maximum allowable error rate output from the latency, error rate, and minimum selected request engine 306. The selected CPU bucket is the CPU bucket of the CPU buckets created by the bucket engine 304 with the lowest CPU cost in terms CPU usage, CPU requests, and number of desired replicas.

A for loop beginning with line 1, repeats the operations represented by lines 2-4 to determine CPU cost for each CPU bucket created by the bucket engine 304. In line 2, a TP80 CPU usage 704 is determined for the CPU usage values in the CPU bucket. TP80 CPU usage 704 is determined by rank ordering the CPU usage values from a smallest CPU usage value to a largest CPU usage value of the CPU usage values in the CPU bucket. The ceiling of the rank ordered values is given by ceil (R*0.95), where R is the number of CPU usage values in the CPU bucket. In line 3, a bucket CPU desire 706 is calculated as a product of the TP80 CPU usage 704 and a CPU request usage ratio. For example, the CPU request usage ratio 708 can be set to 2.0. In line 4, a CPU cost 710 is calculated as the product of the bucket CPU desire 706, and bucket desired replicas 712. For example, the bucket desired replicas 712 can be calculated from an overall application CPU usage over several days divided by the value of the CPU requests from the CPU buckets. The number of days can be 3 days, 4 days, 5 days, 6 days, 7 days or more. In line 5, the CPU buckets are rank ordered from lowest CPU cost to highest CPU cost calculated in lines 1-4.

A for loop beginning with line 6, repeats the operations represented conditional statements in lines 7 and 8 for each CPU bucket starting with the lowest CPU cost up to the highest CPU cost. Lines 7 and 8 are nested conditional statements determine which of the CPU buckets has the lowest CPU cost based on the corresponding bucket error rate and the bucket latency rate. The selected CPU bucket is the CPU bucket with the lowest CPU cost, has a bucket error rate that is less that the maximum allowed error rate 604, and has a bucket latency rate that is less than the maximum allowed latency 602. In line 7, if the bucket error rate 714 is less than the maximum allowed error rate 604 control proceeds to line 8. For example, the bucket error rate 714 can be the TP20 of the error rate of the CPU bucket. In line 8, if the bucket latency rate 716 is less than the maximum allowed latency 602 control proceeds to line 9. For example, the bucket latency rate 716 can be TP80 of the latency of the CPU bucket. In line 9, the selected CPU bucket 718 is CPU bucket with the lowest CPU cost and that satisfies the conditional statements in lines 7 and 8.

FIG. 8 depicts an example pseudocode 800 for calculating the selected CPU limit and the selected CPU memory limit as performed by the recommender engine 310 in FIG. 3. In line 1, a selected CPU request 802 is assigned the value of a CPU desire 804 of the selected CPU bucket 718 determined by the selected bucket engine 308. The CPU desire 804 is the amount of CPU the pod uses to specify a CPU request. For example, the CPU desired 804 can be calculated as the average CPU usage of the CPU bucket multiplied by two. In line 2, the selected CPU limit 806 is calculated as a product of the selected CPU request 802 and the CPU request limit ratio 808. The CPU request limit ratio 808 is recorded in the pod specification. For example, the CPU request limit ratio 808 may be set to a value of 1.2. In line 3, a selected memory request 810 is assigned a memory desire 812 of the selected CPU bucket 718 determined by the selected bucket engine 308. The memory desire 812 is the amount of memory the pod uses to specify a memory request. For example, the memory desired 812 can be calculated as the average memory usage of the CPU bucket multiplied by two In line 4, the selected memory limit 814 is calculated as a product of the selected memory request 810 and the memory request limit ratio 816. The memory request limit ratio 816 is recorded in the pod specification. The memory request limit ratio 816 may be set to a value between a minimum value of 1.2 and a maximum value of 1.5.

The recommender engine 310 calculates a target CPU limit in response to the selected CPU request 802 being less than the current CPU request and calculates a target memory limit in response to the selected memory request 810 being less than the current memory request.

FIG. 9A depicts an example pseudocode 900 for scaling down a target CPU request and a target CPU limit and scaling down a target memory request and a target memory limit. In line 1, if the selected CPU request 802 obtained in FIG. 8 is less than a current CPU request 902 control flows to line 2. In line 2, the target CPU request 904 is calculated as a product of the current CPU request 902 and a scale down factor 906. For example, the scale down factor 906 can be set to 0.7, 0.8, or 0.9. In line 3, the target CPU limit 908 is calculated as a product of the target CPU request 904 and the CPU request limit ratio 808. In line 4, if the selected memory request 810 obtained in FIG. 8 is less than the current memory request 910, control flows to line 5. In line 5, the target memory request 912 is calculated as a product of the current memory request 910 and the scale down factor 906. In line 6, the target memory limit 914 is a product of the target memory request 9012 and the memory request limit ratio 816.

The recommender engine 310 scales up the target CPU request in response to the selected CPU request 802 being greater than the current CPU request and scales up the target memory request in response to the selected memory request 810 being greater than the current memory request as described with reference to FIG. 9B.

FIG. 9B depicts an example pseudocode 916 for scaling up the target CPU request and scaling up the target memory request. In line 1, if the selected CPU request 802 obtained in FIG. 8 is greater than the current CPU request 902, control flows to line 2. In line 2, the target CPU request 904 is calculated as a product of the current CPU request 902 and a scale up factor 920. For example, the scale up factor 920 can be set to 1.2, 1.3, or 1.4. In line 3, if the selected memory request 810 obtained in FIG. 8 is greater than the current memory request 910, control flows to line 4. In line 4, the target memory request 922 is calculated as a product of the current memory request 910 and the scale up factor 920.

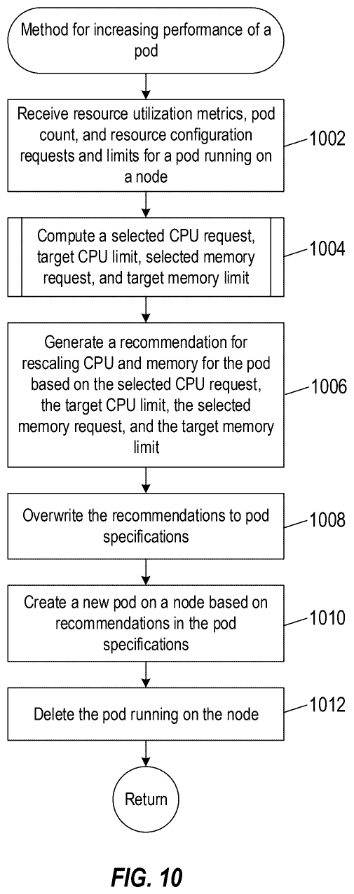

FIG. 10 depicts a flow diagram of a method for adjusting pod resources. The method overcomes problems associated with over provisioning or under provisioning resources used by one or more containers running in the pods.

In block 1002, resource utilization metric, pod count, and resource reconfiguration request and limit for a pod running in a node cluster from a metrics data store as described above with reference to FIGS. 2-3.

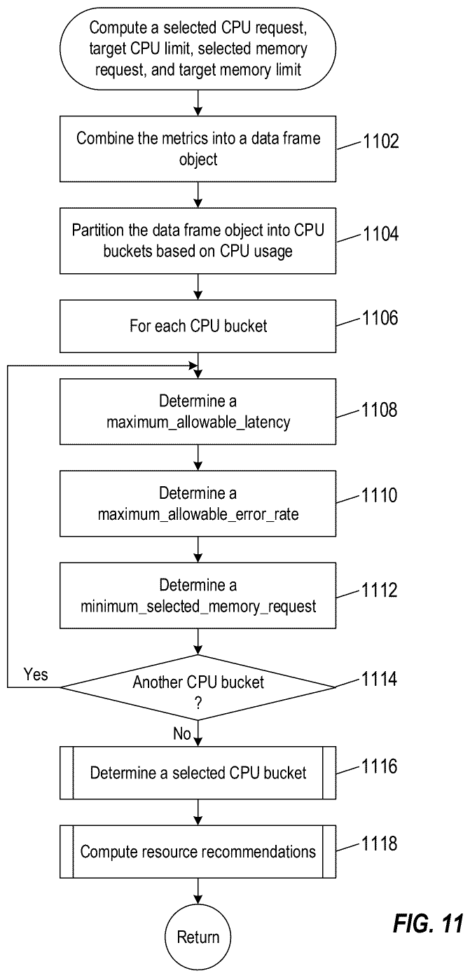

In block 1004, a “compute a selected CPU request, a target CPU limit, a selected memory request, and a target memory limit” process is performed. An example implementation the process in block 1004 is described below with reference to FIG. 11.

In block 1006, a recommendation for rescaling CPU request and limits and memory request and limits based on the selected CPU request, the target CPU limit, the selected memory request, and the target memory limit obtained in block 1004 is generated.

In block 1008, a pod specification is overwritten by the recommendations generated in block 1006.

In block 1010, a new pod is created in accordance with the recommendations in the pod specification on a node in the cluster. The new pod is running with resources that match the demand for resources.

In block 1012, the pod running on the node is deleted from the node cluster. The deleted or previous pod that was running with the prior allocation of resources has been deleted, which overcomes the problems associated with over provisioning or under provisioning resources used by one or more containers that were running in the deleted pod.

FIG. 11 depicts a flow diagram the “compute a selected CPU request, a target CPU limit, a selected memory request, and a target memory limit” process, as in block 1004 of FIG. 10.

In block 1102, the resource utilization metrics are combined into a data frame object as described above with reference to FIGS. 4A-4C.

In block 1104, the data frame object is partitioned into CPU buckets based on CPU

usage as described above with reference to FIGS. 5A-5B.

A loop beginning with block 1106, repeats the operations represented by blocks 1108, 1110, and 1112 for each CPU bucket.

In block 1108, a maximum allowable latency is determined as described above with reference to FIG. 6B.

In block 1110, a maximum allowable error rate is determined as described above with reference to FIG. 6C.

In block 1112, a minimum selected memory request is determined as described above with reference to lines 4-8 in the pseudocode in FIG. 6A.

In block 1114, the operations represented by blocks 1108-1112 are repeated for another CPU bucket.

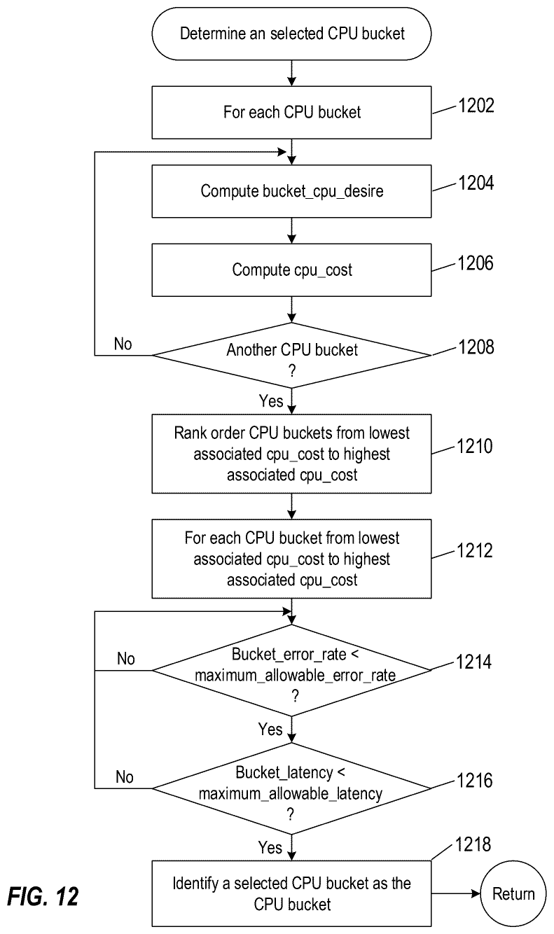

In block 1116, a “determine a selected CPU bucket” process is performed. An example implementation the process in block 1116 is described below with reference to FIG. 12.

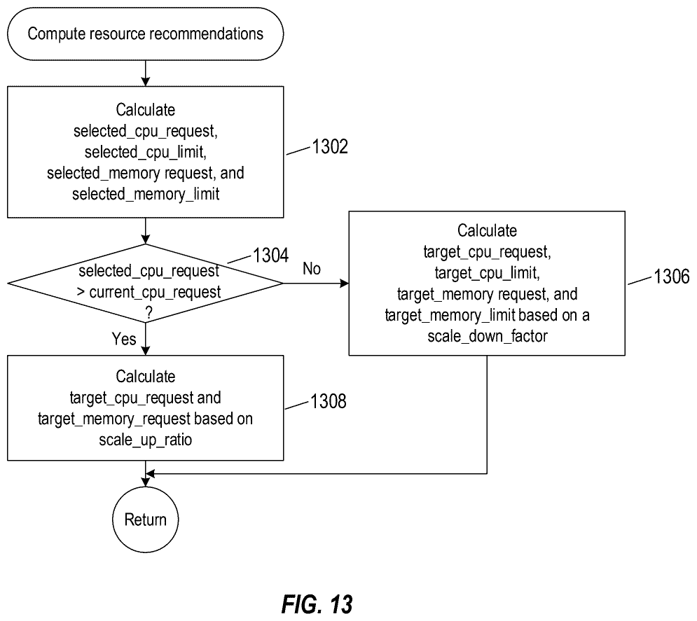

In block 1118, a “compute resource recommendations” process is performed. An example implementation the process in block 1118 is described below with reference to FIG. 13.

The resource recommendations match the resource demands of the pod and avoid over provisioning and under provisioning resource to the newly created pod in block 1010.

FIG. 12 depicts a “determine a selected CPU bucket” process, as in block 1116 of FIG. 11.

A loop beginning with block 1202 repeats the operations represented by blocks 1204 and 1206 for each CPU bucket.

In block 1204, a bucket CPU desire is computed as describe above with reference to line 3 of the pseudocode shown in FIG. 7.

In block 1206, a CPU cost is computed as described above with reference to line 4 of the pseudocode shown in FIG. 7.

In block 1208, the operations represented by blocks 1204 and 1206 for another CPU bucket. Otherwise, control flows to block 1210.

In block 1210, the CPU buckets are rank ordered from lowest associated CPU cost to highest associated CPU cost.

A loop beginning in block 1212 repeats the conditional statements represented by blocks 1214 and 1216 for each CPU bucket.

In block 1214, if the bucket error rate is less than the maximum allowable error as described above with reference to line 7 in FIG. 7, control flows to block 1216.

In block 1216, if the bucket latency is less than the maximum allowable latency as described above with reference to line 8 in FIG. 7, control flows to block 1218.

In block 1218, the CPU bucket is identified the selected CPU bucket as described above with reference to FIG. 5B.

If the bucket error rate is greater than the maximum allowable error in block 1214 or the bucket latency is greater than the maximum allowable latency in block 1216, the loop proceeds to the next CPU bucket.

FIG. 13 depicts a “compute resource recommendation” process, as in block 1118 of FIG. 11.

In block 1302, a selected CPU request, a select CPU limit, a selected memory request, and selected memory limit are computed as described above with reference to lines 1-4 in the pseudocode of FIG. 8.

In block 1304, if the selected CPU request is greater than the current CPU request, control flows to block 1308. Otherwise, control flows to block 1306.

In block 1306, a target CPU request, a target CPU limit, a target memory request, and a target memory limit are computed based on a scale down factor as described above with reference to lines 1-6 in FIG. 9A.

In block 1308, a target CPU request and a target memory request are calculated based on a scale up factor as described above with reference to FIG. 9B.

### Example Processing System for Adjusting CPU and Memory Usage of Pods in a Cluster of Nodes

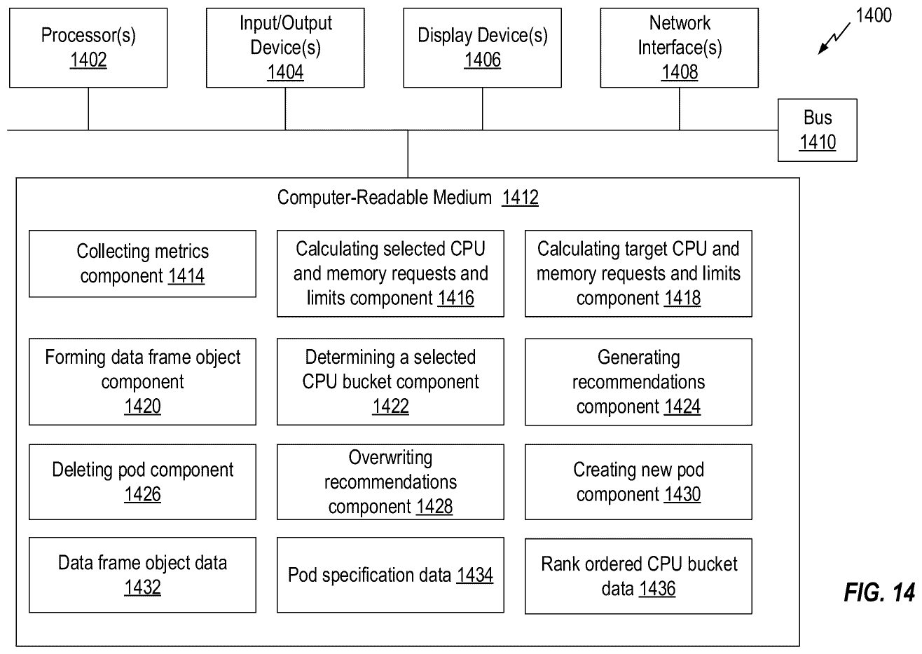

FIG. 14 depicts an example processing system 1400 configured to perform various aspects described herein, including, for example, a method for adjusting pod resources as described above with respect to FIGS. 10-13.

Processing system 1400 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 400 includes one or more processors 1402, one or more input/output devices 1404, one or more display devices 1406, one or more network interfaces 1408 through which processing system 1400 is connected to one or more networks (e.g., a local network, an intranet, the Internet, or any other group of processing systems communicatively connected to each other), and computer-readable medium 1412. In the depicted example, the aforementioned components are coupled by a bus 1410, which may generally be configured for data exchange amongst the components. Bus 1410 may be representative of multiple buses, while only one is depicted for simplicity.

Processor(s) 1402 are generally configured to retrieve and execute instructions stored in one or more memories, including local memories like computer-readable medium 1412, as well as remote memories and data stores. Similarly, processor(s) 1402 are configured to store application data residing in local memories like the computer-readable medium 1412, as well as remote memories and data stores. More generally, bus 1410 is configured to transmit programming instructions and application data among the processor(s) 1402, display device(s) 1406, network interface(s) 1408, and/or computer-readable medium 1412. In certain embodiments, processor(s) 1402 are representative of a one or more central processing units (CPUs), graphics processing unit (GPUs), tensor processing unit (TPUs), accelerators, and other processing devices.

Input/output device(s) 1404 may include any device, mechanism, system, interactive display, and/or various other hardware and software components for communicating information between processing system 1400 and a user of processing system 1400. For example, input/output device(s) 1404 may include input hardware, such as a keyboard, touch screen, button, microphone, speaker, and/or other device for receiving inputs from the user and sending outputs to the user.

Display device(s) 1406 may generally include any sort of device configured to display data, information, graphics, user interface elements, and the like to a user. For example, display device(s) 1406 may include internal and external displays such as an internal display of a tablet computer or an external display for a server computer or a projector. Display device(s) 1406 may further include displays for devices, such as augmented, virtual, and/or extended reality devices. In various embodiments, display device(s) 1406 may be configured to display a graphical user interface.

Network interface(s) 1408 provide processing system 1400 with access to external networks and thereby to external processing systems. Network interface(s) 1408 can generally be any hardware and/or software capable of transmitting and/or receiving data via a wired or wireless network connection. Accordingly, network interface(s) 1408 can include a communication transceiver for sending and/or receiving any wired and/or wireless communication.

Computer-readable medium 1412 may be a volatile memory, such as a random access memory (RAM), or a nonvolatile memory, such as nonvolatile random access memory (NVRAM), or the like. In this example, computer-readable medium 1412 includes a collect metrics component 1414, calculating selected CPU and memory request and limits component 1416, calculating target CPU and memory request and limits component 1418, forming data frame object component 1420, determining selected CPU component 1422, generating recommendations component 1424, deleting pod component 1426, overwriting recommendations component 1428, creating new pod component 1430, data frame object 1432, pod specification data 1434, and rank ordered CPU bucket data 1436.

In certain embodiments, the component 1414 is configured to collect metrics as described above with reference to FIG. 2.

In certain embodiments, the component 1416 is configured to calculate selected CPU and memory requests and limits as described above with reference to FIG. 8.

In certain embodiments, the component 1418 is configured to calculate target CPU and memory requests and limits as described above with reference to FIGS. 9A-9B.

In certain embodiments, the component 1420 is configured to form a data frame object as described above with reference to FIGS. 4B-4C.

In certain embodiments, the component 1422 is configured to determine a selected CPU bucket as described above with reference to FIGS. 5A-5B.

In certain embodiments, the component 1424 is configured to generate recommendations as described above with reference to FIG. 3.

In certain embodiments, the component 1426 is configured to delete an old pod as described above with reference to FIG. 3.

In certain embodiments, the component 1428 is configured to overwrite recommendations in a pod specification as described above with reference to FIG. 3.

In certain embodiments, the component 1430 is configured to create a new pod in accordance with the recommendations as described above with reference to FIG. 3.

In certain embodiments, the component 1432 is a data frame object as described above with reference to FIG. 4C.

In certain embodiments, the component 1434 is pod specification data as described above with reference to FIG. 3.

In certain embodiments, the component 1436 is rank ordered CPU bucket data as described above with reference to FIG. 5B.

Note that FIG. 14 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A computer-implemented method, comprising: receiving resource utilization metrics and resource configuration of a pod running on a node in a cluster of nodes from a metrics collector; computing a selected CPU request, a target CPU limit, a selected memory request, and a target memory limit based on the resource utilization metrics and the resource configuration; generating a recommendation for rescaling CPU and memory for the pod based on the selected CPU request, the target CPU limit, the selected memory request, and the target memory limit; and creating a new pod in the cluster based on the recommendation; and deleting the pod running on the node.

Clause 2. The method of Clause 1, wherein computing the selected CPU request, the target CPU limit, the selected memory request, and the target memory limit comprises: combining the resource utilization metrics to form a data frame object; and partitioning the data frame object into CPU buckets based on intervals of CPU usage.

Clause 3. The method of any of Clause 1-2, wherein computing the selected CPU request, the target CPU limit, the selected memory request, and the target memory limit comprises: for each of the CPU buckets, computing a maximum allowable latency based a latency metric in the resource utilization metrics, and computing a maximum allowable error rate based on an error rate metric in the resource utilization metrics.

Clause 4. The method of any of Clauses 1-3, wherein computing the selected CPU request, the target CPU limit, the selected memory request, and the target memory limit comprises: for each of the CPU buckets, computing a bucket CPU desire, and computing CPU cost based on the bucket CPU desire and a bucket desired replicas; rank ordering the CPU buckets from lowest associated CPU cost to highest associated CPU cost; and determining a selected CPU bucket of the CPU buckets based on the maximum allowable latency and the maximum allowable error rate associated with each of the CPU buckets.

Clause 5. The method of Clauses 1-4 further computing: computing a target CPU request based on a current CPU request and a scale factor; and computing a target memory request based on a current memory request and the scale factor.

Clause 6. The method of Clauses 1-5, wherein generating the recommendation for rescaling the CPU and the memory for the pod comprises: scaling down one of a target CPU request and the target CPU limit based on the selected CPU request being less than a current CPU request; and scaling down one of a target memory request and the target memory limit based on the selected memory request being less than a current memory request.

Clause 7. The method of Clauses 1-6, wherein generating the recommendation for rescaling the CPU and the memory for the pod comprises: scaling up a target CPU request based on the selected CPU request being greater than a current CPU request; and scaling up a target memory request based on the selected memory request being greater than a current memory request.

Clause 8. The method of Clauses 1-7, wherein creating the new pod on the node in the cluster comprises: overwriting a previous recommendation for assigning a CPU request, a CPU limit, a memory request, and a memory limit a pod specification with the recommendation; and creating the new pod based on the recommendation recorded in the pod specification in a rolling update of pods running on the cluster.

Clause 9: A processing system, comprising: a memory comprising computer-executable instructions; and a processor configured to execute the computer-executable instructions and cause the processing system to perform a method in accordance with any one of Clauses 1-8.

Clause 10: A processing system, comprising means for performing a method in accordance with any one of Clauses 1-8.

Clause 11: A non-transitory computer-readable medium storing program code for causing a processing system to perform the steps of any one of Clauses 1-8.

Clause 12: A computer program product embodied on a computer-readable storage medium comprising code for performing a method in accordance with any one of Clauses 1-8.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same clement (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
receiving resource utilization metrics and resource configuration of a pod running on a node in a cluster of nodes from a metrics collector;
computing a selected CPU request, a target CPU limit, a selected memory request, and a target memory limit based on the resource utilization metrics and the resource configuration;
generating a recommendation for rescaling CPU and memory for the pod based on the selected CPU request, the target CPU limit, the selected memory request, and the target memory limit; and
creating a new pod in the cluster based on the recommendation; and
deleting the pod running on the node.

2. The method of claim 1, wherein computing the selected CPU request, the target CPU limit, the selected memory request, and the target memory limit comprises:
combining the resource utilization metrics to form a data frame object; and
partitioning the data frame object into CPU buckets based on intervals of CPU usage.

3. The method of claim 2, wherein computing the selected CPU request, the target CPU limit, the selected memory request, and the target memory limit comprises:
for each of the CPU buckets,
computing a maximum allowable latency based a latency metric in the resource utilization metrics, and
computing a maximum allowable error rate based on an error rate metric in the resource utilization metrics.

4. The method of claim 3, wherein computing the selected CPU request, the target CPU limit, the selected memory request, and the target memory limit comprises:
for each of the CPU buckets,
computing a bucket CPU desire, and
computing cpu cost based on the bucket CPU desire and a bucket desired replicas;
rank ordering the CPU buckets from lowest associated CPU cost to highest associated CPU cost; and
determining a selected CPU bucket of the CPU buckets based on the maximum allowable latency and the maximum allowable error rate associated with each of the CPU buckets.

5. The method of claim 1 further computing:
computing a target CPU request based on a current CPU request and a scale factor; and
computing a target memory request based on a current memory request and the scale factor.

6. The method of claim 1, wherein generating the recommendation for rescaling the CPU and the memory for the pod comprises:
scaling down one of a target CPU request and the target CPU limit based on the selected CPU request being less than a current CPU request; and
scaling down one of a target memory request and the target memory limit based on the selected memory request being less than a current memory request.

7. The method of claim 1, wherein generating the recommendation for rescaling the CPU and the memory for the pod comprises:
scaling up a target CPU request based on the selected CPU request being greater than a current CPU request; and
scaling up a target memory request based on the selected memory request being greater than a current memory request.

8. The method of claim 1, wherein creating the new pod on the node in the cluster comprises:
overwriting a previous recommendation for assigning a CPU request, a CPU limit, a memory request, and a memory limit a pod specification with the recommendation; and
creating the new pod based on the recommendation recorded in the pod specification in a rolling update of pods running on the cluster.

9. A processing system, comprising:
one or more memories comprising computer-executable instructions; and
one or more processors configured to execute the computer-executable instructions and cause the processing system to:
receive resource utilization metrics and resource configuration of a pod running on a node in a cluster of nodes from a metrics collector;
compute a selected CPU request, a target CPU limit, a selected memory request, and a target memory limit based on the resource utilization metrics and the resource configuration;
generate a recommendation for rescaling CPU and memory for the pod based on the selected CPU request, the target CPU limit, the selected memory request, and the target memory limit; and
create a new pod in the cluster based on the recommendation; and
delete the pod running on the node.

10. The processing system of claim 9, wherein to compute the selected CPU request, the target CPU limit, the selected memory request, and the target memory limit the one or more processors are configured to cause the processing system to:
combine the resource utilization metrics to form a data frame object; and
partition the data frame object into CPU buckets based on intervals of CPU usage.

11. The processing system of claim 10, wherein to compute the selected CPU request, the target CPU limit, the selected memory request, and the target memory limit the one or more processors are configured to cause the processing system to:
for each of the CPU buckets,
compute a maximum allowable latency based a latency metric in the resource utilization metrics, and
compute a maximum allowable error rate based on an error rate metric in the resource utilization metrics.

12. The processing system of claim 11, wherein to compute the selected CPU request, the target CPU limit, the selected memory request, and the target memory limit the one or more processors are configured to cause the processing system to:
for each of the CPU buckets,
compute a bucket CPU desire, and
compute cpu cost based on the bucket CPU desire and a bucket desired replicas;
rank ordering the CPU buckets from lowest associated CPU cost to highest associated CPU cost; and
determine a selected CPU bucket of the CPU buckets based on the maximum allowable latency and the maximum allowable error rate associated with each of the CPU buckets.

13. The processing system of claim 9, the one or more processors are configured to cause the processing system to:
compute a target CPU request based on a current CPU request and a scale factor; and
compute a target memory request based on a current memory request and the scale factor.

14. The processing system of claim 9, wherein to generate the recommendation for rescaling the CPU and the memory for the pod the one or more processors are configured to cause the processing system to:
scale down one of a target CPU request and the target CPU limit based on the selected CPU request being less than a current CPU request; and
scale down one of a target memory request and the target memory limit based on the selected memory request being less than a current memory request.

15. The processing system of claim 9, wherein to generate the recommendation for rescaling the CPU and the memory for the pod the one or more processors are configured to cause the processing system to:
scale up a target CPU request based on the selected CPU request being greater than a current CPU request; and
scale up a target memory request based on the selected memory request being greater than a current memory request.

16. The processing system of claim 9, wherein to create the new pod on the node in the cluster the one or more processors are configured to cause the processing system to:
overwrite a previous recommendation for assigning a CPU request, a CPU limit, a memory request, and a memory limit a pod specification with the recommendation; and
create the new pod based on the recommendation recorded in the pod specification in a rolling update of pods running on the cluster.

17. An apparatus, the apparatus comprising:
a metrics collector configured to receive resource utilization metrics and resource configuration of a pod running on a node in a cluster of nodes from a metrics collector;
a bucket engine to partition the resource utilization metrics into CPU buckets based on CPU usage by the pod;
a latency, error rate, and minimum selected request engine to compute for each CPU bucket a maximum allowable latency based on the latency metric, a maximum allowable error rate based on the error rate metric, and a minimum selected memory request;
a select bucket engine to identify a selected CPU bucket of the CPU buckets based on bucket CPU desire and bucket desired replicas; and
a recommender engine to generate a recommendation for rescaling CPU and memory for the pod based on a current CPU request and a current memory request.

18. The apparatus of claim 17 further comprising an updater configured to delete the pod in response to receiving the recommendation from the recommender engine.

19. The apparatus of claim 17 further comprising an admission controller to overwrite a previous recommendation CPU and memory recorded in a pod specification with the recommendation generated by the recommender engine.

20. The apparatus of claim 17 further comprising a deployment controller configured to create a new pod in the cluster in accordance with the recommendation.
